(19) United States
(12) Patent Application Publication
(10) Pub. No.: US 2007/0103290 A1
(43) Pub. Date: May 10, 2007

(54) Monitoring system

(75) Inventors: Kevin D. Kroupa, Ballwin, MO (US); James A. Wilson, Fairview Heights, IL (US); Christopher A. Scholz, Fenton, MO (US)

Correspondence Address: GREENSFELDER HEMKER & GALE PC, SUITE 2000, 10 SOUTH BROADWAY, ST LOUIS, MO, 63102, US

(73) Assignee: Allied Healthcare Products, Inc., St. Louis, MO (US)

(21) Appl. No.: 11/586,056

(22) Filed: Oct. 25, 2006

Related U.S. Application Data
(60) Provisional application No. 60/730,057, filed on Oct. 25, 2005.

(51) Int. Cl. G08B 19/00

(52) U.S. Cl. 340/521

(57) ABSTRACT

A monitoring system to enable a facility to monitor variables for out-of-limit conditions and to signal in response to such an out-of-limit condition, including one or more monitoring panels or so-called alarm panels located for sensing one or more variables at one or more given location within a facility such as a hospital or laboratory to sense and respond to data associated with out-of-limit condition. The one or more panels recognize the existence of an out-of-limit condition so as to determine the nature of the out-of-limit condition, such as underpressure or overpressure, and provide the information regarding such condition so as to enable such a condition to be remedied. One or more panels are selectively provided with one or more circuit modules which can be selectively configured for sensing different conditions in the facility, and the modules provide an assembly of grouped modular configuration with each module monitoring multiple possible variables.

### BACKGROUND AND SUMMARY OF THE INVENTION

The invention relates to systems for monitoring the status of conditions or alarm points or alarm variables in healthcare facilities or institutions and, more particularly, to a monitoring system for use in such facilities or institutions and using monitoring panels of modular character capable of monitoring a plurality of parameters and providing alarms or other communications signifying out-of-limit conditions.

In healthcare and laboratory installations such as hospitals, laboratories, research facilities, clinics and other health-related or scientific or laboratory facilities where there are piped medical gasses, oxygen, clinical vacuum, nitrous oxide, medical air, carbon dioxide, nitrogen, oxygen/carbon dioxide, waste anesthetic gas disposal (WAGD) lines, and various other and also specialty gases, as well as potentially other fluids including gases generally, are provided at various points through such a facility, or where other important parameters may need to be monitored, it is necessary or desired to be able to monitor parameters associated with such substances by the use of electronic sensing, to determine if the varies from a preselected set point. The term “healthcare facility” or simply “facility” is used herein for convenience to refer to all such different kinds of facilities, including those not directly involved in health care per se, such as laboratories and research facilities.

In any such facility, if a gas pressure is the variable or parameter to be sensed by transducer, it is desired to detect underpressure or overpressure conditions. As a specific example, breathing oxygen pressure at a predetermined location may need to be sensed because, if breathing oxygen is too high or too low, patient safety may be compromised.

Typically, gas distribution in a hospital, for example, is monitored by medical gas alarms. The requirements for such alarms have been defined by the National Fire Prevention Association (NFPA). These medical gas alarms are typified by the use of separate alarm modules intended to measure separate lines or sources of gas pressure. That is, each separate module is dedicated to measuring a single gas for a particular parameter, such as pressure, which then displays the output of the pressure transducer in communication with the single gas and is programmed to sound an alarm if the pressure output exceeds or drops below a predetermined threshold. Further, many operating rooms require an additional alarm system dedicated for that particular operating room so a physician or healthcare professional can make sure all systems are functioning properly.

As such, prior art systems to monitor gas distribution handled by a fixed number of gas lines have required a fixed number of separate modules such that there is a monitoring module for each gas line or variable to be monitored. This has required many modules and has led to greatly complicated monitoring systems or so-called “alarm systems,” as well as use of different types of alarm monitoring systems in a given facility.

A simpler, more efficient, and more economical approach is believed to be more appropriate, and is considered to have been achieved in the system of the present invention.

By comparison with the known art, each panel in the presently disclosed system is capable of monitoring the status of a plurality of piped medical gases or other conditions, such as pressure or temperature and giving indication in response thereto.

The present system may for convenience be referred to in this description as a monitoring system in that parameters, variables, functions and values or conditions are monitored and may as monitored be used in typical operation of the monitoring system to provide an aural, visual or other alarm, or to result in a communication of a desired type even if not necessarily an alarm in the strict sense.

The terms “variable”, “condition”, “function”, “parameter” and “condition” and “value” and their equivalents and attributes are used herein interchangeably and in their broadest sense to mean individual attributes (such as temperature, pressure, volume, value, status or other function) to be monitored during operation of the system.

The term “out-of-limit condition” is used in its broadest sense noted hereinabove, and means in general a situation or change of condition wherein such a parameter, variable, condition, function, status, condition or value or any equivalents or attribute thereof varies from predetermined limit or limits, as illustrated by overpressure or underpressure, overtemperature or undertemperature, status change, switch closing or switch opening or other change of status, or unacceptable or undesired or notable change which is desired to be sensed and monitored.

In addition, the term “alarm” is used herein in its broadest sense to connote signals of whatever type, whether electronic, telephonic, radio, video, visual, aural, or otherwise palpable form, as well as providing an alarm or warning, but possibly meaning only the provision of signals that should be noted, recorded or given attention, whether or not alarming or requiring providing a warning, where a situation or change of condition wherein such a parameter, variable, condition, function, condition or value or any equivalents or attribute thereof varies from predetermined limit or limits.

The monitoring system provides wide and flexible capabilities. Various other conditions in addition to pressure can be sensed by the system, such as supply level, liquid level, equipment or zone or fluid temperature, and equipment operation status or other attributes which may need to be monitored as to values or specific functions.

Typical of the presently disclosed monitoring system, and without limitation to the possibility of change, it is desired that where such a parameter (e.g., pressure) to be measured varies by more than 20% (as an exemplary predetermined variance or differential from the a selected set point), being thus too high or too low, sensing must take place and, if needed, an alarm given locally and/or optionally centrally communicated also; and for central monitoring it is necessary to know promptly the physical and/or data address of the alarm at the alarm point. The system provides such capabilities.

The monitoring system uses one or more panels which at respective locations where one or more parameters such as gas pressures are to be monitored. Each such location or alarm point or monitoring point will have a unique address signifying location, as associated with a specific transducer sensing a parameter such as a condition or variable at a location.

The monitoring system may optionally allow a healthcare facility to monitor centrally many such monitoring panels, such as up to 256 separate panels from a central location, to record (i.e., to sense and respond to) data associated with an out-of-limit condition, and to enable such a condition to be remedied promptly.

The monitoring system is also capable of rapidly recognizing the existence of an out-of-limit condition from one of the separate monitoring panels, showing the type of alarm (whether being an out-of-limit condition or an actual alarm), the nature of the out-of-limit condition, such as underpressure or overpressure, and the address of the monitoring panel from which the information is being transmitted.

Printed circuit board (PCB) modules are provided which can be used at each of the separate panels such that each module can be selectively configured for different uses in the monitoring system.

Each panel is a single entity device or unit providing an assembly of grouped modular configuration for monitoring gas source lines for multiple parameters, such as pressure, temperature, etc. The panels can be located throughout a healthcare or laboratory or clinic or other facility with capability for communication with a central facility having a personal-type computer (PC). Specific modules for each panel may have interrelated functions, providing capability for monitoring gas pressures or vacuum lines, and signaling in response to changes in such pressures or relative pressures. A plurality of different gas variables or lines, and switch inputs, can be monitored for signaling and/or alarm purposes, thereby avoiding the need for burdensome multiplication of sensors and alarms as additional variables or lines which might later require monitoring after installation of the monitoring system. The monitoring system is thus readily expandable whether at the panel locations or in the overall sense.

Because the monitoring system may vary in size according to the facility in which it is installed, e.g., whether it be a hospital complex, or a small clinic, the monitoring system is designed and constructed according to a modular design philosophy in order to allow monitoring modules, including PCBs and components thereof, to be selectively configured and then selected for different uses in the monitoring system. In that way the monitoring system facilitates flexible growth. In the monitoring system PCB design is shared by different modules, and identical PCBs can be readily configured with different circuit elements according to the purpose required of the PCB for constructing a specific module. Thus, for the first time, a monitoring system achieves a universality or interchangeability of circuit design features. Economy, efficiency, lowered manufacturing cost, and extraordinary performance and reliability are gained from this novel design philosophy in the monitoring system.

It will be seen from the foregoing and from the following description that among the features, and advantages of the present invention are the provision of a monitoring system with features designed to monitor the status of piped medical gases, including WAGD lines, and the respective delivery pressures of each gas or relative vacuum; which is capable of providing an alarm or otherwise signaling or providing communication upon the occurrence of a predetermined variance of a variable or parameter from a preset set point; which is capable of reporting such conditions to a central monitoring facility; which is useful to alert system users to situations that may cause personal injury or jeopardy, or equipment damage; which is capable of modem telecommunication of other out-of-limit conditions; which is capable of responding to further alarm or out-of-limit conditions even after an initial fault is detected; which includes self-test features to ensure proper operation; which provides visual display features which give rapid visual indication of relative levels or values being monitored so as to give the user quick assessment of conditions; which is capable of detecting and giving warning of discrete conditions such as normal, abnormal, “in use” and “out of use” which are being sensed; which operates safely over a wide variety of operating conditions; which provides high accuracy of operation over a wide range of possible variables or parameters being sensed; and which is capable of quick, safe, reliable and economic installation; and which is economically and reliably configured; and which may be expanded as may be required.

### BRIEF DESCRIPTION OF DRAWINGS

FIG. 1 is a simplified diagram of a monitoring system;

FIG. 2 shows a monitoring panel containing modules with configured circuit boards;

FIG. 3 is a flow chart diagram illustrating the operation of a control module of the monitoring panel;

FIG. 4 is a flow chart diagram illustrating the operation of an 8-transducer module of the monitoring panel;

FIG. 5 is a flow chart diagram illustrating the operation of a 10-switch signal module of the monitoring panel;

FIG. 6 is a flow chart diagram illustrating the operation of a pressure/vacuum module and a dual module of the monitoring panel;

FIG. 7 is a flow chart diagram illustrating the operation of a data converter board of the monitoring panel;

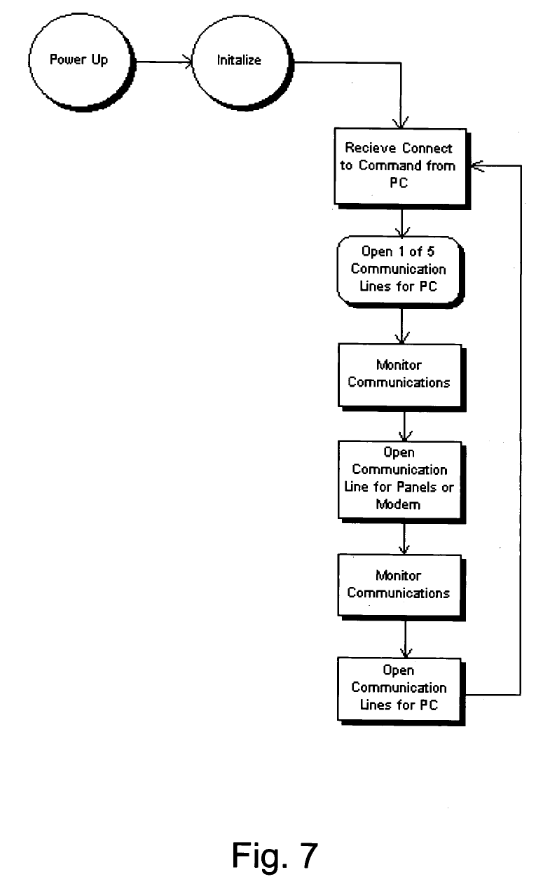

FIG. 8 is a schematic circuit diagram universally descriptive of each of the control module, the 8-transducer module, and the 10-switch signal module;

FIG. 9 is a schematic circuit diagram universally descriptive of the data converter board;

FIG. 10 is a schematic circuit diagram universally descriptive of each of the pressure/vacuum module and the dual module; and

FIG. 11 is a wiring diagram showing installation of the monitoring panel of the general type shown in FIG. 2.

Corresponding reference characters identify corresponding elements throughout the several views of the drawings.

### DETAILED DESCRIPTION

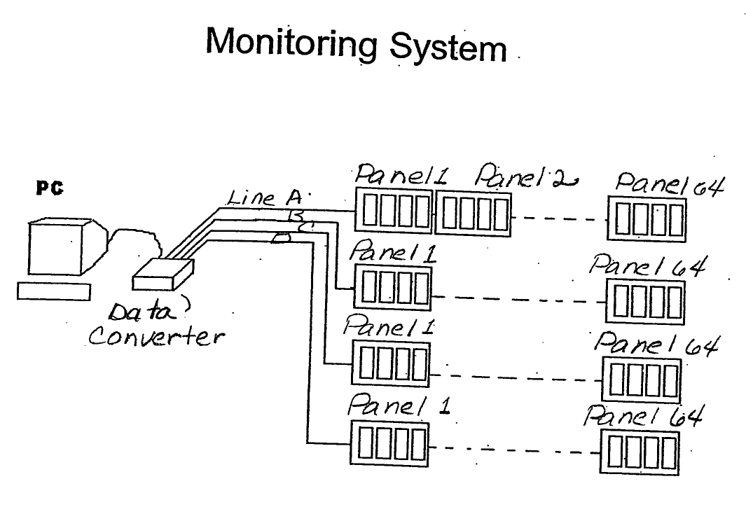

Referring to the drawings, a monitoring system is illustrated and generally designated as 10 in FIG. 1. In this implementation, the monitoring system 10 may include a computer system 12 which is electronically connected by a data converter 14 to one or more panels 16 such that the data converter 14 provides monitoring data from one or more data lines 18 to computer system 12.

One or more panels 16 are provided that monitor status of one or more measurable variables. Each panel 16 is a single entity device or unit (as more fully described below) providing an assembly of grouped modular configuration for monitoring gas source lines for multiple parameters, such as pressure, temperature, etc. The panels 16 can be located throughout a healthcare or laboratory or clinic or other facility with capability for communication with computer system 12 which may be a PC including the usual keyboard and printer or printers and other accessories, all as being part of the usual peripheral device 12′, for example, a PC, including various cabling and connections as well as wired or wireless communication capabilities as shown below the PC pictorial representation 12 and which do not need to be separately illustrated.

A printer (not shown) may be used with computer system 12 should be suitable capable of making a printout or other hard copy of desired data, such as a log of out-of-limit conditions reported from the panels with time and location data.

The computer system 12 may be operatively associated with optional network access devices of peripheral device 12′ in order to enable computer system 12 to contact outside resources to transmit and store data. Outside resources may include computer or computer services on an intranet or an extranet. Any such network access device may include an internal or external network card, a modem, and other wired and wireless accesses devices as will be appreciated in the art, as well as pager connections and facilities. Thus, when out-of-limit conditions are reported by data converter 14 to computer system 12, it may have programming to cause a pager call to be made so that maintenance or supervisory person will learn of the nature of the fault or condition, its location, and the need to take action.

Peripheral devices 12′ may include information and data storage capacity to hold and retain data in a digital form for access by computer system 12 and may comprise primary and/or secondary storage, and may include memory. Storage may comprise, for example, a hard drive having at least 500 megabytes of free hard disk space and at least 128 megabytes of RAM (random access memory).

Specific modules of each panel 16 are described below to provide interrelated functions for receiving input from sensors from either a remote location or the immediate location, or both, and reporting of variables and for providing out-of-limit condition indications if an input variable differs from a set point by a predetermined differential or variance such as plus or minus 20%. Modules for pressure sensing are capable of monitoring a pressure of a plurality of different gas variables or lines, and modules for switch sensing are capable of monitoring a plurality of different switch inputs.

In one embodiment, up to sixty-four panels 16 may be operatively connected on signal data line 18. Of course, the monitoring system 10 may be operatively connected to more than sixty-four panels 16. Panels 16 may use RS-485 protocol to communicate over data lines 18. Other protocols, whether known or yet to be implemented, are possible. One implementation of one of the panels 16 is described in greater detail below. Other implementations of one or more panels 16 are also contemplated.

The data lines 18 transmit the monitoring data from panels 16 to data converter 14. In one embodiment, data lines 18 may each connect one or more panels 16 in a series, while in another possible embodiment data lines 18 can connect one or more panels 16 in parallel. Other implementations of the data lines 18 are possible.

Data converter 14 coordinates the transmission and reception of data between one or more panels 16 and computer system 12. One implementation of data converter 14 is described in greater detail below.

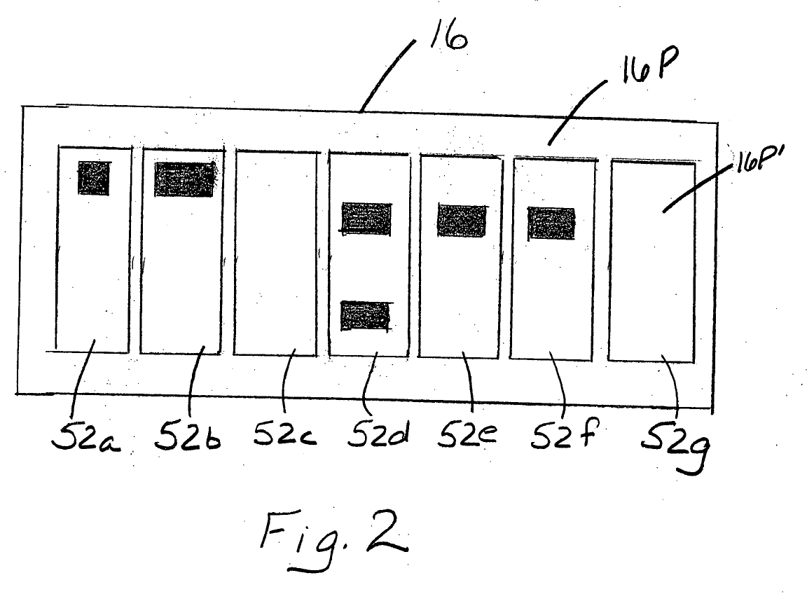

FIG. 2 shows one of possible configuration monitoring panels 16 containing modules 52 of an actual typical installation intended for a facility to employ the invention. Monitoring panel 16 comprises control module 52a, and sensing modules 52b-g, including an 8-transducer module 52b, a 10-switch signal module 52c, a dual display module 52d, a pressure module 52e, a vacuum module 52f and a blank module 52g (which serves as spare or blank to permit expansion by the use one of the several modules, such as pressure or vacuum module, at a later time). The numbering of the modules is for convenience relative to the technical and engineering development of the modules, and otherwise has no special significance in this description. The several modules are surrounded by a face plate or bezel 16P. Each of the modules has a respective face plate, and that for the control module is designated 16P′ as being typical.

Various displays (whether alphanumeric or as a vertical or other LED array) of the modules will be evident without need for specific enumeration in that each module (other than the blank module) is constructed by a respective printed circuit board on which there will be present circuit elements (including the displays and switches and LEDs, etc.) corresponding to or represented by the panel view.

Thus, the skilled artisan will recognize that there are a discrete series of PCBs used to constitute a panel installation. The PCBs comprises the following: control module, 8-transducer module, 10-switch signal module, pressure/vacuum module, dual module, and data converter board.

### Panel Monitoring Functions

The monitoring system 10 provides monitoring and variable-sensing functions and features which are carried out by panels 16 which are located at various points in a facility using the monitoring system 10.

The term “panel” is a convenient terminology to connote an array of modules 52, according to desired interrelationships of modules 52 and the predetermined functions to be provided by them, the number of variables (e.g., conditions or parameters) to be sensed by them, and the type of communication or alarm to be provided in response to an out-of-limit condition. The term “panel” is similarly not intended to be limited to a specifically preferred physical arrangement as disclosed herein. Instead, these terms merely refer to a suitable array or related grouping of modules 52, as in adjacent or closely-grouped relation and with the modules 52 enclosed in a suitable box (or boxes) or other enclosure types such as for panel-type wall or wall-surface mounting according to customer needs and specifications.

Control Module

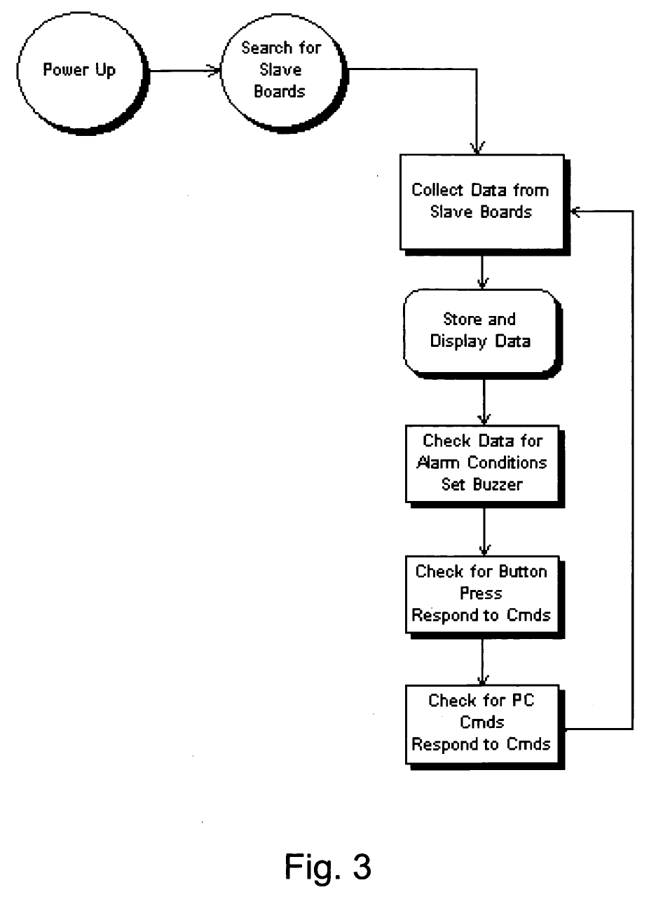

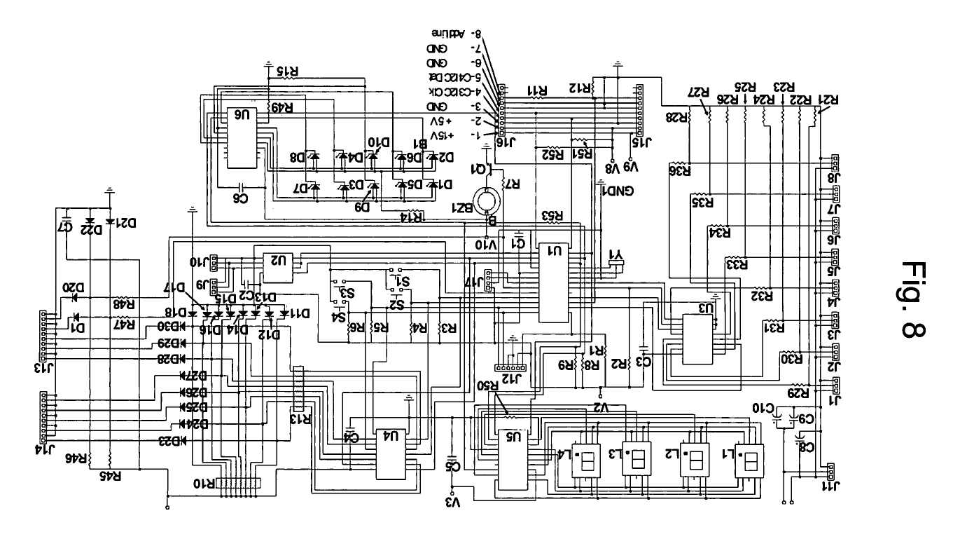

The control module 52a may be the first module in each panel 16. FIG. 3 is a flow chart diagram illustrating the operation of the control module 52a of the panel 16. The disclosure of FIG. 3 illustrating the operation of the control module 52a is incorporated by reference herein. The control module 52a, which serves as the human interface to program the modules 52a-g of the panel 16, sounds a buzzer when there is an out-of-limit condition (which may be termed an “alarm”) which detected by one of the sensing modules 52b-g, and communicates with the computer system 12. It is provided by the use of a PCB having circuitry in accordance with FIG. 8 and may include the following components:

TABLE 1
Control Module Components
Designation

BZ1
C1, C2, C5, C7
C8, C9, C10
D10
D10
J12
J9, J10, J11
J16
L2, L3
Q1
R1
R3, R4, R5, R6, R7, R8, R9, R50, R51, R52
R11, R15
R14
S1, S2, S3, S4
S1, S2, S3, S4
U1
U2
U5
Y1

Referring to FIG. 8, an audible alarm may be activated by a buzzer BZ1 as driven by transistor Q1 in response to an alarm condition detected by sensing modules 52b-g. Thus, other modules 52b-g do not require the provision of a buzzer, which feature is present only on the control module 52a.

It should be kept in mind that that PCB layout shown in FIG. 8 can be configured according to whether the PCB, the control module 52a, 8-transducer module 52b, or the 10-Switch signal module 52c.

Regardless of the PCB layout for sensing modules 52b-g, it is emphasized that a communication chip U2 is used only for the control module 52a, being an RS458 communication chip that relays information back to the central PC if the latter is present. As shown, switches S1-S4 also are present only on the control module 52a such that switches S1-S4 they allow the user to program the monitoring panel 16. When the new monitoring system is first installed, it is necessary to set up the sensor types and the set points. Switches S1-S4 may be used for that purpose.

In addition, terminals J15 and J16 may be terminals for connection of the cable (not shown) that links together the various modules 52a-g.

8-Transducer Module

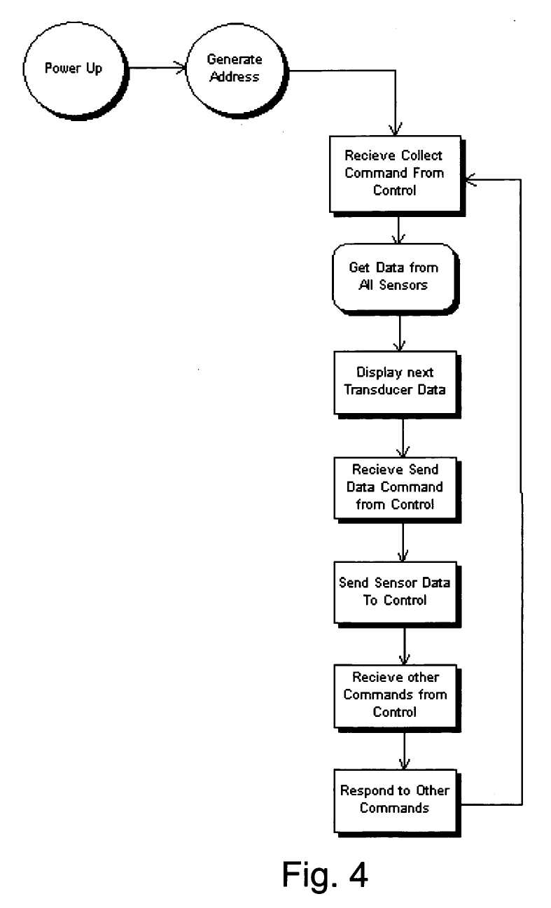

Referring to FIG. 4, a flow chart diagram of an 8-transducer module 52b of the panel 16 illustrates the operation of the 8-transducer module and is incorporated by reference herein. On power up the processor will read the voltage on one of the lines coming from the control module and determine its local address. The module 52b receives and responds to commands from the control module. The 8-transducer module 52b has inputs for as many as eight transducers and provides one bi-color LED display for each input (e.g., red and green). This module has four 7-segment LEDs to display data from each of the transducers. The processor first displays data from transducer 1 (if it is present) and flashes the bi-color LED for transducer 1. After a couple of seconds have expired the processor switches the four 7-segment LEDs to display data from transducer 2 and flashes the bi-color LED for transducer 2. The processor will cycle through each transducer in the same manner and then start over again. The 8-transducer module or module is provided by the use of a PCB having circuitry in accordance with FIG. 8 having the following components:

TABLE 2
8-Transducer Module Components
Designation

C1, C4, C6, C7
C8, C9, C10
D1, D2, D3, D4, D5, D6, D7, D8, D9, D10
D1, D2, D3, D4, D5, D6, D7, D8, D9, D10
D11, D12, D13, D14, D15, D16, D17, D18, D19, D20, D21, D22, D23,
D24, D25, D26, D27, D28, D29, D30, J12
J13, J14
J15, J16
R1
R8, R9, R45, R46, R47, R48, R49, R51, R52
R10, R13
R11
R12
R53
U1
U4
U6
Y1

As shown in FIG. 8, J1-J8 are transducer inputs. These transducer inputs are monitored by U3, a multiplexer (MUX). Controller E1 addresses each of eight inputs (J11-J8) through U3 and then reads back the data from whichever input is provided through whichever input has been addressed. The data so read is displayed on LED displays L1-L4. Shown at U5 is a driver for these displays.

With reference to FIG. 3, the flow chart diagram for the 8-transducer module 52b and signal flow for the circuitry of FIG. 8 will be understood by those with ordinary skill in the art.

For provision of the 8-transducer module 52b, the inputs J13 and J14 are not needed for the 8-transducer module 52b and accordingly the diodes isolating those inputs are not required except for the 10-switch module, discussed below.

Dual 4-input multiplexer U4 may be used to multiplex the inputs, so that eight inputs are provided on only four lines which are presented with on outputs 2Y, 1Y, 4Y and 3Y of U4, and these lines provide inputs back to the main processor U1.

U6 may be an LED driver which drives diodes LEDs D1-D10, which show, if a transducer being sensed is out-of-limit by 20% above or below the set point. Thus, for the 8-transducer module 52b, LEDs D1-D10 show transducer conditions. J15 and J16 may be terminals for connection of the cable that links the various modules.

10-Switch Signal Module

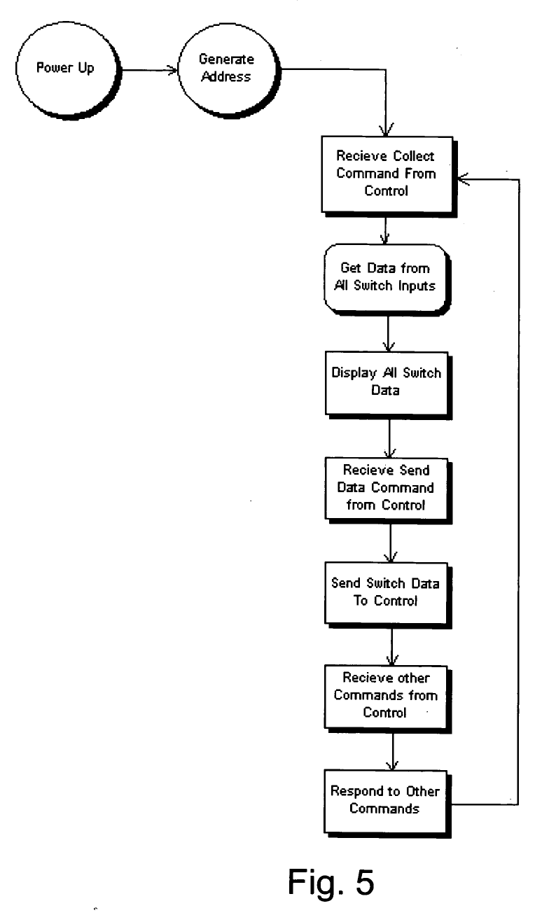

Referring to FIG. 5, a flow chart diagram illustrates the operation of a 10-switch signal module 52c and is incorporated by reference herein. On power up the processor will read the voltage on one of the lines coming from the control module and determine its local address. The 10-switch signal module 52c receives and responds to commands from the control module. In addition, the 10-switch signal module 52c has inputs for as many as 10 switches and one bi-color LED for each input. The LED's show the status of the inputs. The 10-switch signal module 52c may be provided by the use of a PCB having circuitry in accordance with FIG. 8 having the following components:

TABLE 3
10-Switch Module Components
Designation

C1, C3, C5, C6, C7
C8, C9, C10
D3, D4, D5, D6, D7, D8, D9, D10
D3, D4, D5, D6, D7, D8, D9, D10
J1, J2, J3, J4, J5, J6, J7, J8, J12
J15, J16
L1, L2, L3, L4
R1R29, R30, R31, R32, R33, R34, R35, R36
R2, R8, R9, R49, R50, R51, R52
R11
R12
R21, R22, R23, R24, R25, R26, R27, R28, U1
U3
U5, U6
Y1

With reference to FIG. 8, U6 serves as the LED driver which drives diodes LEDs D1-D10, which show switch conditions if a switch signal is open.

Pressure/Vacuum Module

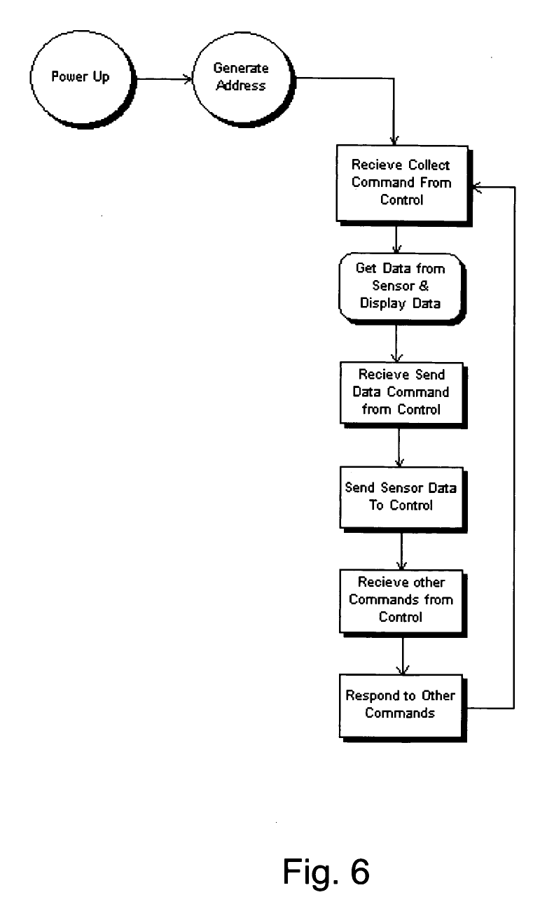

Referring to FIG. 6, a flow chart diagram illustrates the operation of a pressure/vacuum module 52e/52f and of a dual module 52d of the panel 16 and is incorporated by reference herein. The term “pressure/vacuum module” means that such module 52e/52f can be used either for monitoring gas pressure or gas relative vacuum, or can monitor any sensor that provides electrical input in a desired range. On power up the processor of the pressure/vacuum module 52e/52f will read the voltage on one of the lines coming from the control module and determine its local address. The pressure/vacuum module 52e/52f receives and responds to commands from the control module and has inputs for transducers, and is provided with a vertical stacked “bar graph” array or row of LEDs and had three 7-seven segment LEDs for numeric display of variables being sensed so that data from the sensor input is continuously displayed on the LEDs. In addition, the pressure/vacuum module also has three normally closed switch outputs. One such closed switch output is open when there is a “high alarm” condition, one is open when in “low alarm” status and one is open when conditions are in alarm.

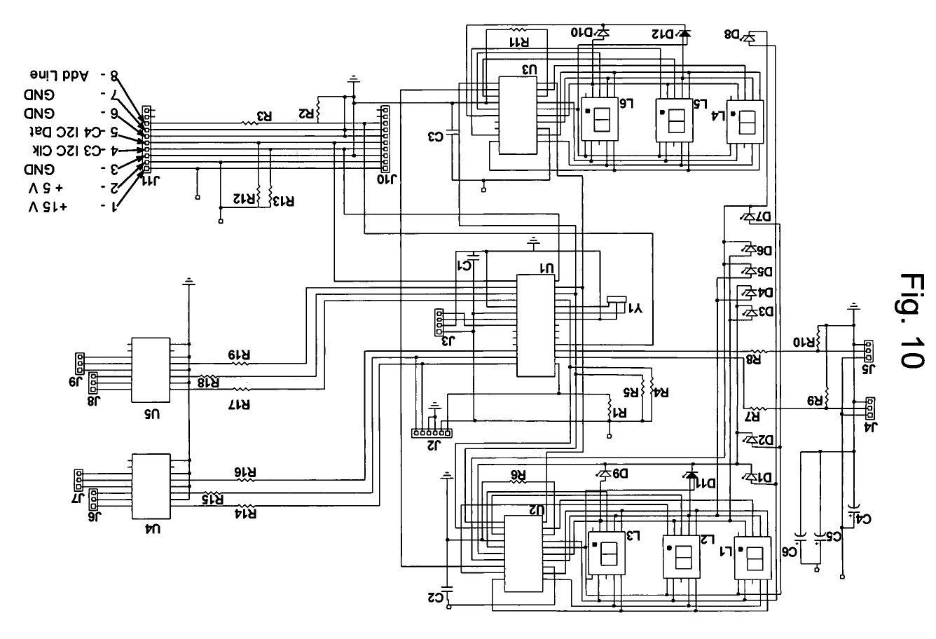

FIG. 10 is a schematic circuit diagram universally descriptive of the pressure/vacuum module 52e/52f and the dual module 52d. For the present pressure/vacuum module purposes, a PCB having circuitry in accordance with FIG. 10 is provided with the following components:

TABLE 4
Pressure/Vacuum Module Components
Designation

C1, C2
C4, C5, C6
D1, D8
D2, D7
D3, D4, D5, D6
D1, D2, D3, D4, D5, D6, D7, D8
J12
J4, J8, J9
J10, J11
L1, L2, L3
R1, R7
R2
R3
R4, R5, R6, R12, R13
R9
R17, R18, R19
U1
U2
U5
Y1

Referring to FIG. 10, as used for the pressure/vacuum function as well as for the dual module 52g, some elements are present for one function but not for other functions. For providing a pressure/vacuum sensing function, LED driver U2 is used for driving the LED displays L1-L3, as well LEDs D1-D7 which provide bar graph type display to show relative pressure, for example, by which a higher pressure would be shown by more LEDs extending the light bar up. As such, LEDs D1-D8 are arrayed in a vertical array as if they were a bar of lights.

Dual Module

FIG. 10 is a schematic circuit diagram also universally descriptive of the dual module 52d. On power up the processor will read the voltage on one of the lines coming from the control module and determine its local address. The dual module 52d receives and responds to commands from the control module. The dual module 52d has inputs for two transducers, two rows of LEDs and two sets of 3 seven segment LEDs. Data from the transducer inputs is continuously displayed on the LEDs. In addition, the dual module 52d also has two sets of 3 normally closed switch outputs. One for each transducer is open when in High Alarm, one is open when in Low Alarm and one is open when conditions are in Alarm. For the dual module 52d purposes, a PCB having circuitry in accordance with FIG. 10 is provided with the following components:

TABLE 5
Dual Module Components
Designation

C1, C2, C3
C4, C5, C6
D1, D8, D9, D10
D11, D12
D1, D8, D9, D10, D11, D12
J12
J4, J5, J6, J7, J8, J9
J10, J11
L1, L2, L3, L4, L5, L6
R1, R7, R8
R2
R3
R4, R5, R6, R11, R12, R13
R9, R10
R14, R15, R16, R17, R18, R19
U1
U2, U3
U4, U5
Y1

By comparison with the pressure/vacuum module 52e/52f, the configuration of the dual module will not need that type of display, where instead LEDs D1, D9 and D11 operate to show the condition on sensor 2. Sensors 1 and 2 are connected by inputs J4 and J5. Sensor 1 is driven from the central processor U1 and it reads inputs from the transducers and then sends signals to U2 and U3 if present to drive the LEDs to display the data as 7-segment displays. Integrated circuits U4 and U5 may be used to output alarm conditions to other panels 16 by means of switch outputs provided on outputs J6-J9.

Data Converter Board

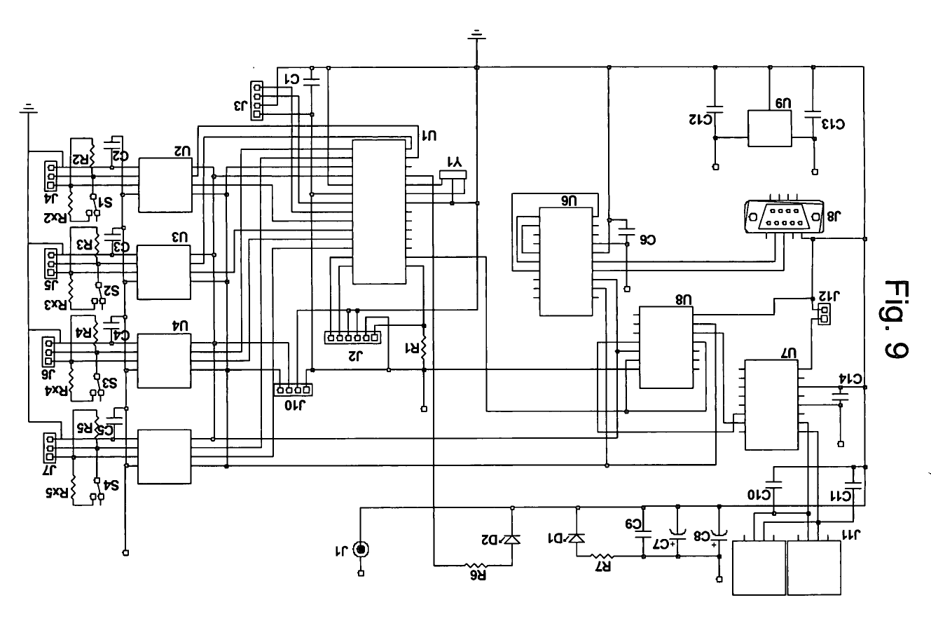

Referring to FIG. 1, the data converter board 14 or module acts as a liaison between the computer system 12 and up to 256 panels 16. The data converter board has four inputs for RS-485 communication cables, each of these communication cables can daisy chain to up to sixty-four panels 16. There is also an onboard modem and connections for a phone line as well as an RS-232 connector for connection to computer system 12. The data converter board receives and responds to commands from the computer system 12, thereby allowing the computer system 12 to send and receive data to and from any of the 256 panels 16. The data converter board will also allow the computer system 12 to communicate on the phone line via the modem. For the data converter board purposes, a PCB having circuitry in accordance with FIG. 9 is provided with the following components:

TABLE 6
Data Converter Board Components
Designation

C1, C2, C3, C4, C5, C6, C7, C12, C13, C14
C8, C9
C10, C11
D1
D2
J1
J4, J5, J6, J7
J8
J11
J2
J3
J10
J12
S1, S2, S3, S4
Rx2, Rx3, Rx4, Rx5
R1
R6, R7
R2, R3, R4, R5
U1
U2, U3, U4, U5
U6
U7
U7
U8
U9
Y1

With reference to FIG. 9, processor U1 will read information coming from the PC through the communications chip U6 an RS232 transceiver, which reads RS232 communication from the computer system 12. U1 allows communications to pass through or to not pass through U2-U5 which goes out to the various lines of panels 16 and U2-U5 are RS-485 communication chips. U1 also enables or disables communications to and from a modem U7 through J11 (phone IN/OUT). Other LEDs are D1 as a Power ON indicator and D2 as a communication activity indicator. A connector J8 may be provided for computer interface.

Operation of the System

Because each panel 16 is a single entity device or unit providing an assembly of grouped modular configuration for monitoring gas source lines for multiple parameters, such as pressure, temperature, etc., the panels 16 can be located as needed now or in the future throughout a healthcare or laboratory or clinic or other facility with capability for communication with a central facility having computer system 12, as shown in FIG. 1. Specific modules of each panel 16 are seen to have interrelated functions. Each pressure/vacuum module 52e/52f used for pressure or vacuum sensing provides a novel capability for monitoring pressure of a plurality of different gas variables or lines, and whereas the 10-switch modules 52c disclosed are useful for switch sensing are capable of monitoring a plurality of different switch inputs, thus avoiding the need for burdensome multiplication of sensors and alarms as additional variables or lines are to be later monitored after installation of the system.

Installation of the System

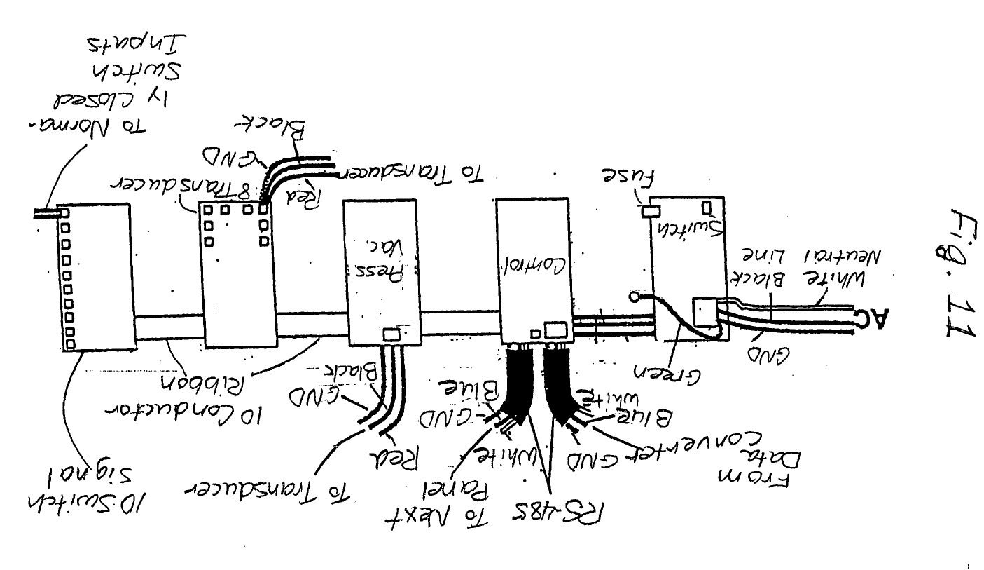

Referring to FIG. 11, a wiring diagram illustrates the installation of a panel 16 of the general type shown in FIG. 2, it will be understood that 10-conductor ribbon cabling is used to connect several modules 52, including a control module 52a, a pressure/vacuum module 52e/52f, and 8-transducer module 52b and a 10-switch module 52c, all as indicated by legends. It will be seen that the RS-485 protocol cable connection is made at the control module 52a, for communication purposes. A connection to the data converter 14 of FIG. 1 is also made at the control module so that the control module can provide out-of-limit condition signaling (alarm signaling) and location address data to the computer system 12. By the use of such 10-conductor cabling, a panel 16 may conveniently be formed by daisy chain connection of a suitable number of modules 52, so that the panels 16 may be as simple as desired or as elongated as may be needed at a specific location. The modular series for a panel 16 can therefore be assembled to meet a specific facility need according to the types and numbers of variables that will need to be monitored by the monitoring system 10.

It will now be understood that a panel 16 of the remote monitoring assembly, which consists of a control module as well as several monitoring modules, is used in the following ways:

Information from individual sensors, (transducers) and the monitoring module(s) of panels 16 as described operate to determine accordingly whether a variable has exceeded a predetermined variation from a set point. A control module 52a of the panel 16 monitors the monitoring modules 52b-g and collects information from them. If one of the variables being monitored varies from a set point by more than a predetermined value, such as 20%, plus or minus, the control module will detect the anomalous reading, and may be configured to provide a warning or alarm, whether visual and/or aural and/or otherwise, and it is convenient in healthcare facilities where patient treatment is involved that the warning be both aural and visual. If the panel 16 is connected to the computer system 12, it will then transmit that information on to the computer system 12. Therefore, it is to be understood that the monitoring modules 52b-g are those which sense variations from a set point, whereas the control module 52a of a panel 16 collects the data for local signaling or alarm purposes and, optionally, sends such communication to a remote location (such as a central control) for recordation and taking of action. One such action may be to actuate a warning at the central station or location for supervisory determination of the need for action. Another such action may be to call a pager by which a maintenance or supervisory person will learn of the nature of the alarm condition, its location, and the need to take action.

A panel 16 can display output to monitor a plurality gas sources (typically up to eight individual gas sources, according to a disclosed embodiment) for various parameters, values functions or conditions, such as pressure, temperature, etc. Preferably, the single unit has a plurality of transducers with each transducer being in communication with a respective gas source and preferably comprises one-four digit display and eight lights, although other display arrangements may be contemplated. For example, a light may be dedicated for each of the transducer inputs used to monitor gas pressure or other parameter with a “red” light indicating an alarm and a “green” light indicating normal status; however, other displays which display numerical values for various gas parameters may be used. Panel 16 saves wall space, permits installation in minimal time and achieves excellent function and reliability without high cost.

A facility can have one or more panels 16, as shown in FIG. 1, as would be typically appropriate for a large healthcare facility. Thus, the reader can see from FIGS. 1, 2 and 11 how the monitoring system 10 may vary in size according to the facility in which it is installed, e.g., whether it be a hospital complex, or a small clinic. It is to be appreciated that the monitoring system 10 is designed and constructed according to a modular design philosophy in order to allow modules and components thereof to be selectively configured and then selected for different uses in the monitoring system 12, and to be added as the monitoring system 10 may be expanded to sense more variables and/or to provide panels 16 at various locations within the facility.

Although the foregoing includes a description of the best mode contemplated for carrying out the invention, various modifications are contemplated. As various modifications can be made in the constructions and methods herein described and illustrated without departing from the scope of the invention, it is intended that all matter contained in the foregoing description or shown in the accompanying drawings shall be interpreted as illustrative rather than limiting.

1. A monitoring system to enable a facility to monitor variables for out-of-limit conditions and to signal in response to such an out-of-limit condition, the system comprising:
at least one monitoring panel located for receiving input from one or more variables at a given location within the facility to receive and respond to data associated with an out-of-limit condition;
said at least one monitoring panel recognizing the existence of an out-of-limit condition so as to determine the nature of the out-of-limit condition, such as underpressure or overpressure, and provide the information regarding such condition so as to enable such a condition to be remedied; and
said at least one monitoring panel being selected provided with one or more circuit modules which can be selectively configured for sensing different conditions in the facility.

2. The monitoring system as set forth in claim 1 wherein the multiple possible variables include gas pressures, temperatures or switch status in the facility.

3. The monitoring system as set forth in claim 2 wherein each of said monitoring panels comprises a facility for communication with a central facility to communicate information about the existence of out-of-limit conditions of said possible variables.

4. The monitoring system as set forth in claim 3 wherein:
each of said monitoring panels provides a local indication of out-of-limit condition; and optionally centrally communicated also; and
said each of said monitoring panels provides communication by communication protocol for central monitoring by computer at a central facility for knowledge centrally of physical and/or data address of out-of-limit conditions monitored by the monitoring panels.

5. The monitoring system as set forth in claim 4 wherein each of said monitoring panels provides a unique alarm point or monitoring point having a unique address signifying its location, and
each panel has provision for signaling the specific existence of an out-of-limit condition at said location.

6. The monitoring system as set forth in claim 5 wherein each of said panels includes provision for providing one or more of the following:
at least one module of collecting data from a plurality of different gas variables, whether pressure or relative vacuum, for out-of-limit conditions;
at least one module of collecting the data of a plurality of switch inputs, for out-of-limit conditions.

7. The monitoring system as set forth in claim 5 wherein each of said panels includes provision for providing one or more of the following:
at least one module of collecting data from a plurality of a first type of variables for out-of-limit conditions; and
at least one module of collecting data from a plurality of a second type of variables for out-of-limit conditions.

8. The monitoring system as set forth in claim 3 wherein each of said panels is readily expandable by daisy-chain addition of modules for collecting data of selected variables for out-of-limit conditions.

9. The monitoring system as set forth in claim 8 wherein each of said modules communicates with a central modules of a panel by RS-485 communication protocol.

10. The monitoring system as set forth in claim 3 wherein each of said panels comprises:
a control module for providing data communications with a central facility if present; and
at least one module for least one module of sensing a plurality of variables for out-of-limit conditions for communicating said out-of-limit condition to said control module.

11. The monitoring system as set forth in claim 10 further comprising such a central facility, and said central facility is a computer system, and wherein said control module provides data communications to said computer facility including data address for said out-of-limit conditions.

12. The monitoring system as set forth in claim 3 wherein each of said panels comprises:
a control module for providing data communications with a central facility if present; and
at least one module for least one module of collecting data from a plurality of variables for out-of-limit conditions for communicating said out-of-limit condition to said control module.

13. The monitoring system as set forth in claim 3 wherein:
each of said panels provides for daisy-chain connection of a suitable number of modules for sensing a selected number of variables at the location of the respective panel;
wherein the panels each may be as simple as desired or as elongated as may be needed at a specific location; and
wherein a modular series for a panel can therefore be assembled to meet a specific facility need according to the types and numbers of variables that will need to be monitored.

14. The monitoring system as set forth in claim 1 wherein out-of-limit condition is a preselected differential from a predetermined set point.

15. The monitoring system as set forth in claim 14 wherein out-of-limit condition is represented by differential of less than or more than 20% from the predetermined set point.

16. The monitoring system as set forth in claim 1 wherein each panel has at least one module for monitoring multiple possible variables.

17. A monitoring system to enable a facility to monitor variables for out-of-limit conditions and to signal in response to such an out-of-limit condition, the system comprising:
at least one monitoring panel located for receiving input from one or more variables at a given location within the facility to receive and respond to data associated with an out-of-limit condition;
said at least one monitoring panel recognizing the existence of an out-of-limit condition so as to determine the nature of the out-of-limit condition, such as underpressure or overpressure, and provide the information regarding such condition so as to enable such a condition to be remedied; and said at least one monitoring panel being selected provided with one or more circuit modules which can be selectively configured for sensing different conditions in the facility;
wherein each of said panels comprises:
a control module for providing data communications with a central facility if present; and
at least one module for collecting data from a plurality of variables for out-of-limit conditions and for communicating said out-of-limit condition to said control module; wherein the multiple possible variables include gas pressures, temperatures or switch status in the facility; wherein each of said monitoring panels comprises a facility for communication with a central facility to communicate information about the existence of out-of-limit conditions of said possible variables.

18. The monitoring system as set forth in claim 17 wherein the at least one module for sensing a plurality of variables for out-of-limit conditions for communicating said out-of-limit condition to said control module is an 8-transducer module.

19. The monitoring system as set forth in claim 18 wherein the at least one module is a switch signal module.

20. The monitoring system as set forth in claim 19 wherein the at least one module is a dual module.
